(19) United States
(12) Patent Application Publication
(10) Pub. No.: US 2025/0202122 A1
(43) Pub. Date: Jun. 19, 2025

(54) ANTENNA STRUCTURE

(71) Applicant: Wistron NeWeb Corp., Hsinchu (TW)

(72) Inventors: Chih-Feng TAI, Hsinchu (TW); Kuei-Cheng WANG, Hsinchu (TW); De-Shao YAO, Hsinchu (TW)

(21) Appl. No.: 18/954,851

(22) Filed: Nov. 21, 2024

(30) Foreign Application Priority Data
Dec. 15, 2023 (TW) 112149040

(51) Int. Cl. H01Q 13/10; H01Q 1/38; H01Q 1/50; H01Q 5/307

(52) U.S. Cl. CPC H01Q 13/10; H01Q 1/38; H01Q 1/50; H01Q 5/307

(57) ABSTRACT

An antenna structure includes a metal mechanism element, a ground element, a first radiation element, a second radiation element, and a dielectric substrate. The metal mechanism element has a slot. The ground element is coupled to the metal mechanism element. The first radiation element is coupled to a feeding point. The first radiation element is also coupled to a grounding point on the ground element. The second radiation element is coupled to the feeding point. The second radiation element is adjacent to the first radiation element. The dielectric substrate is adjacent to the slot of the metal mechanism element. The ground element, the first radiation element, and the second radiation element are disposed on the dielectric substrate.

### CROSS REFERENCE TO RELATED APPLICATIONS

This application claims priority of Taiwan Patent Application No. 112149040 filed on Dec. 15, 2023, the entirety of which is incorporated by reference herein.

### BACKGROUND OF THE DISCLOSURE

### Field of the Disclosure

The disclosure generally relates to an antenna structure, and more particularly, to a wideband antenna structure.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHZ, 850 MHz, 900 MHz, 1800 MHZ, 1900 MHZ, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. If an antenna used for signal reception and transmission has insufficient bandwidth, it will negatively affect the communication quality of the mobile device in which it is installed. Accordingly, it has become a critical challenge for antenna designers to design a small-size, wideband antenna element.

### BRIEF SUMMARY OF THE DISCLOSURE

In an exemplary embodiment, the disclosure is directed to an antenna structure that includes a metal mechanism element, a ground element, a first radiation element, a second radiation element, and a dielectric substrate. The metal mechanism element has a slot. The ground element is coupled to the metal mechanism element. The first radiation element is coupled to a feeding point. The first radiation element is further coupled to a grounding point on the ground element. The second radiation element is coupled to the feeding point. The second radiation element is adjacent to the first radiation element. The dielectric substrate is adjacent to the slot of the metal mechanism element. The ground element, the first radiation element, and the second radiation element are all disposed on the dielectric substrate.

### BRIEF DESCRIPTION OF DRAWINGS

The disclosure can be more fully understood by reading the subsequent detailed description and examples with references made to the accompanying drawings, wherein:

FIG. 1 is a top view of an antenna structure according to an embodiment of the disclosure;

FIG. 2A is a partial view of elements of an antenna structure according to an embodiment of the disclosure;

FIG. 2B is a partial view of elements of an antenna structure according to another embodiment of the disclosure;

FIG. 3 is another partial view of elements of an antenna structure according to an embodiment of the disclosure;

FIG. 4 is a side view of an antenna structure according to an embodiment of the disclosure;

FIG. 5 is a diagram of VSWR (Voltage Standing Wave Ratio) of an antenna structure according to an embodiment of the disclosure;

FIG. 6 is a top view of an antenna structure according to another embodiment of the disclosure; and

FIG. 7 is a diagram of VSWR of an antenna structure according to another embodiment of the disclosure.

### DETAILED DESCRIPTION OF THE DISCLOSURE

In order to illustrate the purposes, features and advantages of the disclosure, the embodiments and figures of the disclosure are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

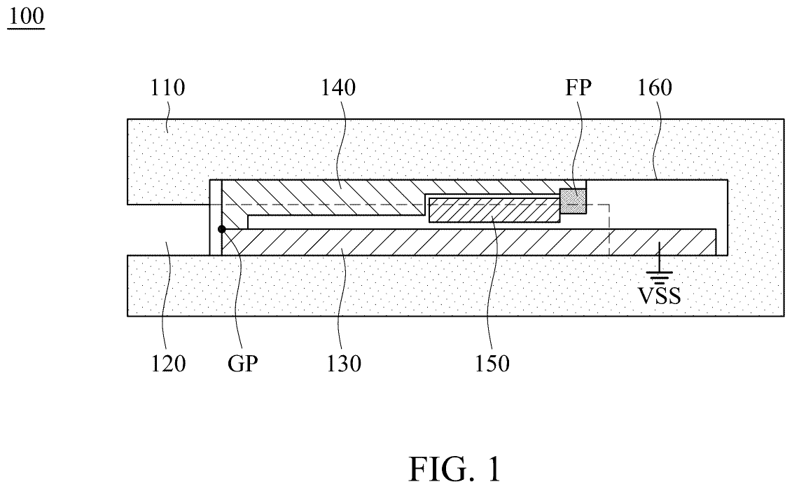

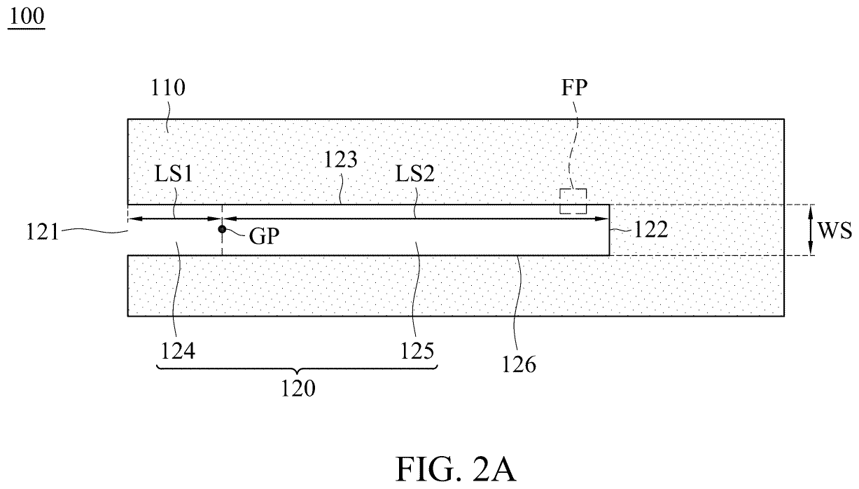

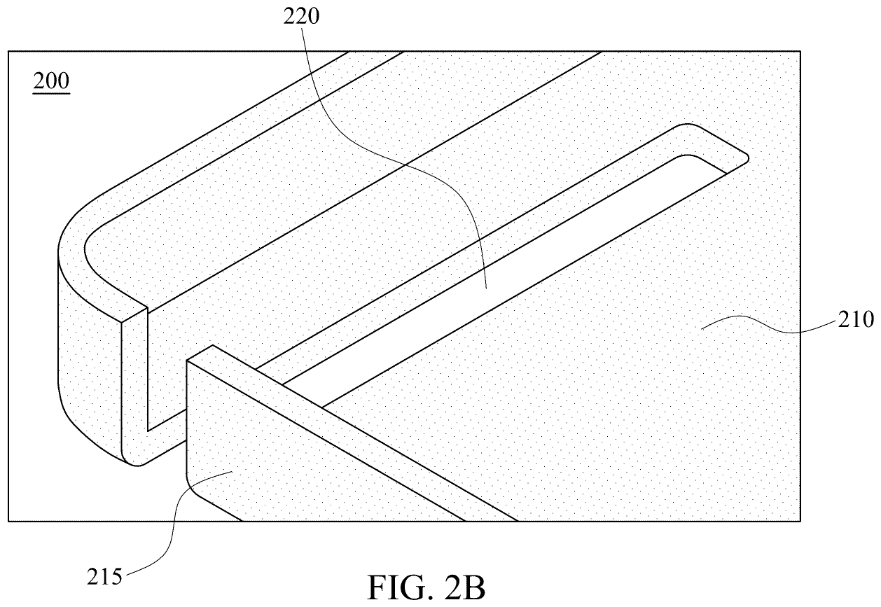

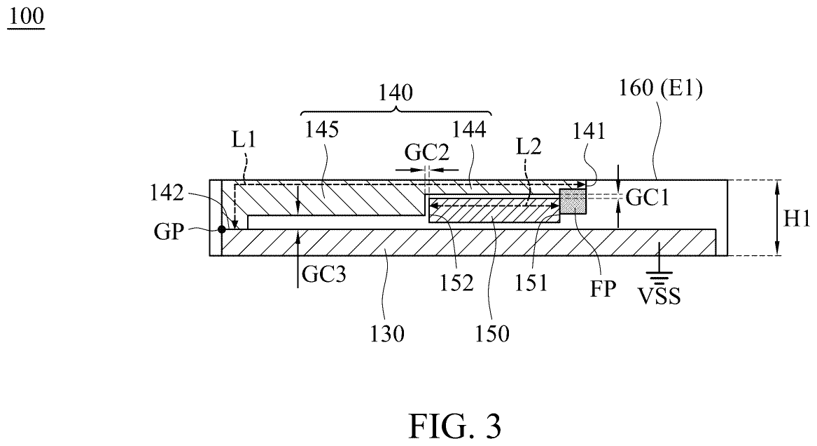

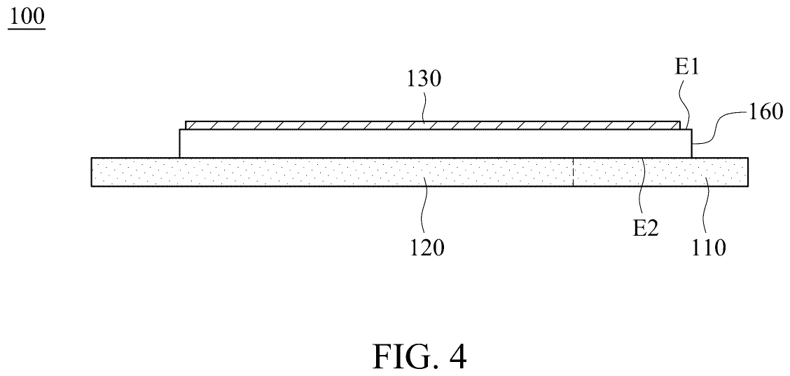

FIG. 1 is a top view of an antenna structure 100 according to an embodiment of the disclosure. FIG. 2A is a partial view of elements of the antenna structure 100 according to an embodiment of the disclosure. FIG. 3 is another partial view of elements of the antenna structure 100 according to an embodiment of the disclosure. FIG. 4 is a side view of the antenna structure 100 according to an embodiment of the disclosure. Please refer to FIG. 1, FIG. 2A, FIG. 3 and FIG. 4 together. The antenna structure 100 may be applied to a mobile device, such as a smart phone, a tablet computer, or a notebook computer. In the embodiment of FIG. 1, FIG. 2A, FIG. 3 and FIG. 4, the antenna structure 100 includes a metal mechanism element 110, a ground element 130, a first radiation element 140, a second radiation element 150, and a dielectric substrate 160. The ground element 130, the first radiation element 140, and the second radiation element 150 may all be made of metal materials, such as copper, silver, aluminum, iron, or their alloys.

For example, the metal mechanism element 110 may be a metal back cover of a notebook computer, but it is not limited thereto. The metal mechanism element 110 has a slot 120. The slot 120 of the metal mechanism element 110 may substantially have a straight-line shape. Specifically, the slot 120 may be an open slot with an open end 121 and a closed end 122 away from each other. Also, the slot 120 has two edges 123 and 126 which are opposite to each other. In some embodiments, the antenna structure 100 further includes a nonconductive material (not shown), which fills the slot 120 of the metal mechanism element 110, so as to achieve the waterproof or dustproof function.

The dielectric substrate 160 may be an FR4 (Flame Retardant 4) substrate, a PCB (Printed Circuit Board), or a FPC (Flexible Printed Circuit). The dielectric substrate 160 has a first surface E1 and a second surface E2 which are opposite to each other. The ground element 130, the first radiation element 140, and the second radiation element 150 may all be disposed on the first surface E1 of the dielectric substrate 160. The second surface E2 of the dielectric substrate 160 is adjacent to the slot 120 of the metal mechanism element 110. It should be noted that the term “adjacent” or “close” over the disclosure means that the distance (spacing) between two corresponding elements is smaller than a predetermined distance (e.g., 10 mm or the shorter), or means that the two corresponding elements directly touch each other (i.e., the aforementioned distance/spacing between them is reduced to 0). In some embodiments, the second surface E2 of the dielectric substrate 160 is directly attached to the metal mechanism element 110, such that the dielectric substrate 160 can at least partially cover the slot 120 of the metal mechanism element 110.

The ground element 130 is coupled to the metal mechanism element 110. The shape of the ground element 130 is not limited in the disclosure. For example, the ground element 130 may be implemented with a ground copper foil, which may extend from the first surface E1 of the dielectric substrate 160 onto the metal mechanism element 110. In some embodiments, the ground element 130 is also configured to provide a ground voltage VSS.

The first radiation element 140 has a first end 141 and a second end 142. The first end 141 of the first radiation element 140 is coupled to a feeding point FP. The second end 142 of the first radiation element 140 is coupled to a grounding point GP on the ground element 130. The feeding point FP may be further coupled to a signal source (not shown). For example, the signal source may be an RF (Radio Frequency) module for exciting the antenna structure 100. Specifically, the first radiation element 140 includes a narrow portion 144 adjacent to the first end 141 and a wide portion 145 adjacent to the second end 142. The narrow portion 144 is also coupled to the feeding point FP. The wide portion 145 is also coupled to the grounding point GP. In some embodiments, the first radiation element 140 has a first vertical projection on the metal mechanism element 110, and the first vertical projection at least partially overlaps the slot 120 of the metal mechanism element 110. In some embodiments, the first radiation element 140 substantially has a variable-width L-shape, but it is not limited thereto.

The second radiation element 150 is disposed between the first radiation element 140 and the ground element 130. The second radiation element 150 has a first end 151 and a second end 152. The first end 151 of the second radiation element 150 is coupled to the feeding point FP. The second end 152 of the second radiation element 150 is an open end. The second radiation element 150 is adjacent to the first radiation element 140. A first coupling gap GC1 may be formed between the second radiation element 150 and the narrow portion 144 of the first radiation element 140. A second coupling gap GC2 may be formed between the second radiation element 150 and the wide portion 145 of the first radiation element 140. In addition, a third coupling gap GC3 may be formed between the ground element 110 and the wide portion 145 of the first radiation element 140. In some embodiments, the second radiation element 150 has a second vertical projection on the metal mechanism element 110, and the second vertical projection at least partially overlaps the slot 120 of the metal mechanism element 110. In some embodiments, the second radiation element 150 substantially has a relatively short straight-line shape, but it is not limited thereto.

In some embodiments, the aforementioned feeding point FP is implemented with a feeding metal piece coupled to the signal source. The feeding metal piece may be respectively coupled to the first end 141 of the first radiation element 140 and the first end 151 of the second radiation element 150. However, the disclosure is not limited thereto. In alternative embodiments, the antenna structure 100 further includes a coaxial cable coupled to the signal source. A central conductor of the coaxial cable includes a bifurcated feeding element, so as to feed in the first end 141 of the first radiation element 140 and the first end 151 of the second radiation element 150, respectively. It should be understood that the bifurcated feeding element can be considered as the aforementioned feeding point FP.

As shown in FIG. 2A, the positions of the feeding point FP and the grounding point GP can represent their projection points on the metal mechanism element 110. In some embodiments, the feeding point FP is aligned with the edge 123 of the slot 120 of the metal mechanism element 110. In other words, the projection point of the feeding point FP may be exactly positioned at the edge 123 of the slot 120. In addition, the grounding point GP or its projection point may be positioned inside the slot 120 of the metal mechanism element 110. With respect to the grounding point GP, the slot 120 of the metal mechanism element 110 can be divided into a short portion 124 adjacent to the open end 121 and a long portion 125 adjacent to the closed end 122. That is, the grounding point GP may be exactly positioned at the junction between the short portion 124 and the long portion 125 of the slot 120.

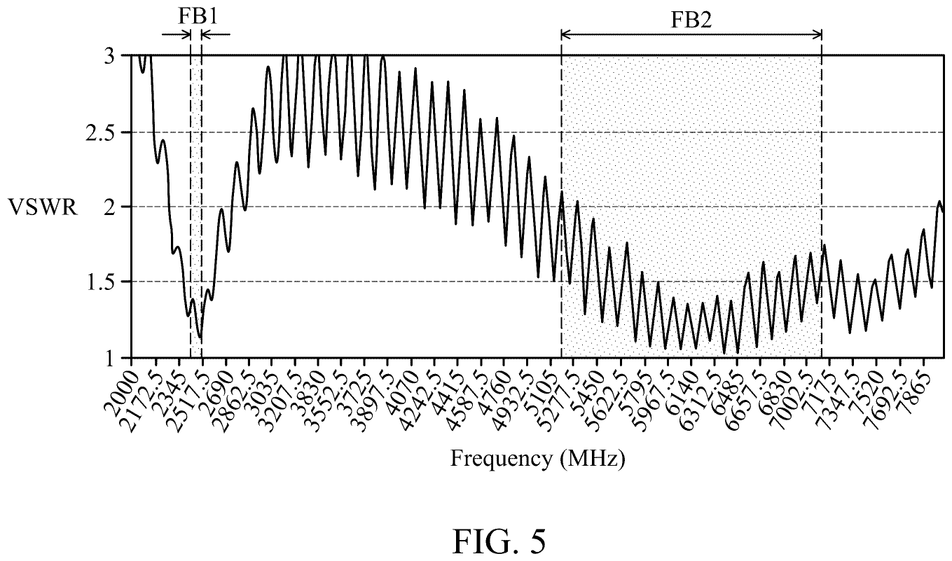

FIG. 5 is a diagram of VSWR (Voltage Standing Wave Ratio) of the antenna structure 100 according to an embodiment of the disclosure. The horizontal axis represents the operational frequency (MHz), and the vertical axis represents the VSWR. According to the measurement of FIG. 5, the antenna structure 100 can cover a first frequency band FB1 and a second frequency band FB2. For example, the first frequency band FB1 may be from 2400 MHz to 2500 MHz, and the second frequency band FB2 may be from 5150 MHz to 7125 MHz. Therefore, the antenna structure 100 can support at least the wideband operations of WLAN (Wireless Local Area Network), Wi-Fi 6E and Wi-Fi 7.

In some embodiments, the operational principles of the antenna structure 100 will be described as follows. Because the design of the grounding point GP is used, the slot 120 of the metal mechanism element 110 corresponds to different operational frequency bands of the antenna structure 100. In the metal mechanism element 110, the short portion 124 of the slot 120 can be excited to generate the second frequency band FB2, and the long portion 125 of the slot 120 can be excited to generate the first frequency band FB1. According to practical measurements, the first radiation element 140 and the second radiation element 150 are arranged to fine-tune the impedance matching of the second frequency band FB2.

In some embodiments, the element sizes of the antenna structure 100 will be described as follows. In the metal mechanism element 110, the length LS1 of the short portion 124 of the slot 120 may be substantially equal to 0.25 wavelength (24) of the second frequency band FB2 of the antenna structure 100, the length LS2 of the long portion 125 of the slot 120 may be substantially equal to 0.25 wavelength (λ/4) of the first frequency band FB1 of the antenna structure 100, and the width WS of the slot 120 may be from 1 mm to 3 mm (e.g., about 2 mm). The length L1 of the first radiation element 140 may be substantially equal to 0.5 wavelength (λ/2) of the second frequency band FB2 of the antenna structure 100. The length L2 of the second radiation element 150 may be from 3 mm to 7 mm (e.g., about 7 mm). The width of the first coupling gap GC1 may be from 0.2 mm to 0.7 mm (e.g., about 0.2 mm). The width of the second coupling gap GC2 may be from 0.2 mm to 3 mm (e.g., about 0.2 mm). The width of the third coupling gap GC3 may be from 0.2 mm to 1 mm (e.g., about 0.5 mm). The height H1 of the dielectric substrate 160 may be from 2 mm to 4 mm (e.g., about 3 mm). The above ranges of element sizes are calculated and obtained according to many experimental results, and they help to optimize the operational bandwidth and the impedance matching of the antenna structure 100.

FIG. 2B is a partial view of elements of an antenna structure 200 according to another embodiment of the disclosure. FIG. 2B is similar to FIG. 2A. In the embodiment of FIG. 2B, a metal mechanism element 210 of the antenna structure 200 further includes a sidewall element 215. As a result, a slot 220 of the metal mechanism element 210 may substantially have a 3D (Three-Dimensional) L-shape, which may further extend onto the sidewall element 215. According to practical measurements, This L-shaped slot design further reduces the overall size of the antenna structure 200. Other features of the antenna structure 200 of FIG. 2B are similar to those of the antenna structure 100 of FIG. 2A. Therefore, the two embodiments can achieve similar levels of performance.

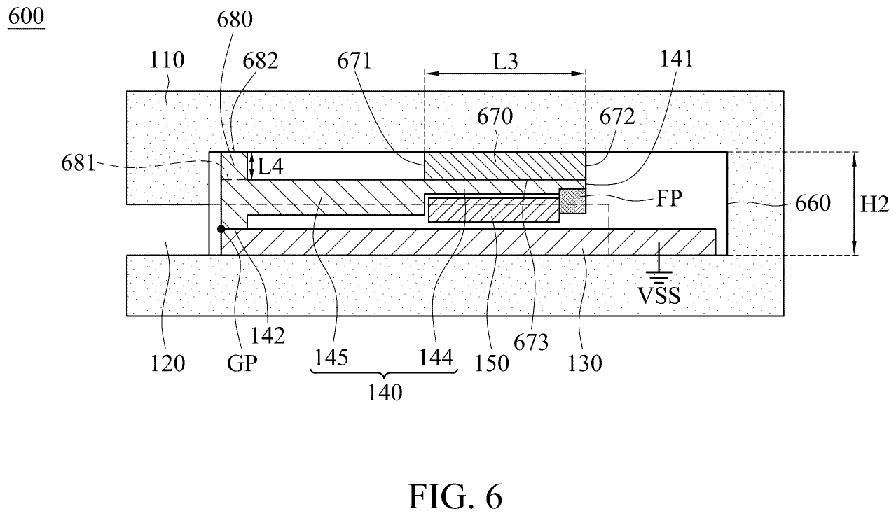

FIG. 6 is a top view of an antenna structure 600 according to another embodiment of the disclosure. FIG. 6 is similar to FIG. 1. In the embodiment of FIG. 6, the dielectric substrate 660 of the antenna structure 600 has a greater height H2, and the antenna structure 600 further includes a third radiation element 670 and a fourth radiation element 680. Specifically, the third radiation element 670 has a first end 671, a second end 672, and a side 673. Each of the first end 671 and the second end 672 of the third radiation element 670 is an open end. The side 673 of the third radiation element 670 is coupled to the narrow portion 144 of the first radiation element 140. For example, the narrow portion 144 of the first radiation element 140 may be disposed between the third radiation element 670 and the second radiation element 150. Furthermore, the fourth radiation element 680 has a first end 681 and a second end 682. The first end 681 of the fourth radiation element 680 is coupled to the wide portion 145 of the first radiation element 140. The second end 682 of the fourth radiation element 680 is an open end. For example, the second end 682 of the fourth radiation element 680 and the second end 142 of the first radiation element 140 may substantially extend in opposite directions and away from each other. In some embodiments, the height H2 of the dielectric substrate 660 may be from 4 mm to 5 mm (e.g., about 4.4 mm), the length L3 of the third radiation element 670 may be from 2 mm to 6 mm (e.g., about 6 mm), and the length L4 of the fourth radiation element 680 may be from 1 mm to 2 mm (e.g., about 1.4 mm). In some embodiments, the third radiation element 670 substantially has a relatively long straight-line shape (compared with the second radiation element 150), and the fourth radiation element 680 substantially has a rectangular shape or a square shape, but they are not limited thereto.

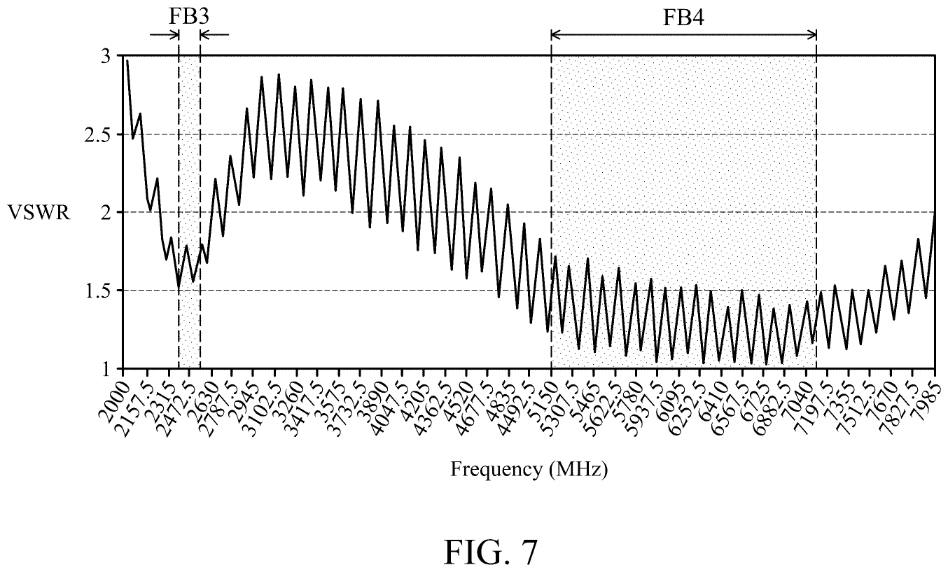

FIG. 7 is a diagram of VSWR of the antenna structure 600 according to another embodiment of the disclosure. The horizontal axis represents the operational frequency (MHz), and the vertical axis represents the VSWR. According to the measurement of FIG. 7, the antenna structure 600 can cover a first frequency band FB3 and a second frequency band FB4. For example, the first frequency band FB3 may be from 2400 MHz to 2500 MHz, and the second frequency band FB4 may be from 5150 MHz to 7125 MHz. According to the comparison between FIG. 7 and FIG. 5, the incorporation of the third radiation element 670 and the fourth radiation element 680 can improve the impedance matching of the second frequency band FB4, such that the radiation efficiency of the antenna structure 600 can be further enhanced within the second frequency band FB4. Other features of the antenna structure 600 of FIG. 6 are similar to those of the antenna structure 100 of FIG. 1. Therefore, the two embodiments can achieve similar levels of performance.

The disclosure proposes a novel antenna structure. In comparison to the conventional design, the disclosure has at least the advantages of smaller size, wider bandwidth, higher radiation efficiency, and lower manufacturing cost. Therefore, the disclosure is suitable for application in a variety of mobile communication devices.

Note that the above element sizes, element shapes, and frequency ranges are not limitations of the disclosure. An antenna designer can fine-tune these settings or values in order to meet specific requirements. It should be understood that the antenna structure of the disclosure is not limited to the configurations depicted in FIGS. 1-7. The disclosure may merely include any one or more features of any one or more embodiments of FIGS. 1-7. In other words, not all of the features displayed in the figures should be implemented in the antenna structure of the disclosure.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna structure, comprising:
a metal mechanism element, having a slot;
a ground element, coupled to the metal mechanism element;
a first radiation element, coupled to a feeding point, wherein the first radiation element is further coupled to a grounding point on the ground element;
a second radiation element, coupled to the feeding point, wherein the second radiation element is adjacent to the first radiation element; and
a dielectric substrate, disposed adjacent to the slot of the metal mechanism element, wherein the ground element, the first radiation element, and the second radiation element are disposed on the dielectric substrate.

2. The antenna structure as claimed in claim 1, wherein the slot of the metal mechanism element is an open slot.

3. The antenna structure as claimed in claim 1, wherein the slot of the metal mechanism element substantially has a straight-line shape or an L-shape.

4. The antenna structure as claimed in claim 1, wherein the feeding point is aligned with an edge of the slot of the metal mechanism element.

5. The antenna structure as claimed in claim 1, wherein the grounding point is positioned inside the slot of the metal mechanism element.

6. The antenna structure as claimed in claim 1, wherein the first radiation element comprises a narrow portion and a wide portion, the narrow portion is coupled to the feeding point, and the wide portion is coupled to the grounding point.

7. The antenna structure as claimed in claim 6, wherein a first coupling gap is formed between the second radiation element and the narrow portion of the first radiation element, and a width of the first coupling gap is from 0.2 mm to 0.7 mm.

8. The antenna structure as claimed in claim 7, wherein a second coupling gap is formed between the second radiation element and the wide portion of the first radiation element, and a width of the second coupling gap is from 0.2 mm to 3 mm.

9. The antenna structure as claimed in claim 8, wherein a third coupling gap is formed between the ground element and the wide portion of the first radiation element, and a width of the third coupling gap is from 0.2 mm to 1 mm.

10. The antenna structure as claimed in claim 1, wherein the second radiation element is disposed between the first radiation element and the ground element.

11. The antenna structure as claimed in claim 1, wherein with respect to the grounding point, the slot of the metal mechanism element is divided into a short portion and a long portion.

12. The antenna structure as claimed in claim 11, wherein the antenna structure covers a first frequency band and a second frequency band.

13. The antenna structure as claimed in claim 12, wherein the first frequency band is from 2400 MHz to 2500 MHz, and the second frequency band is from 5150 MHz to 7125 MHz.

14. The antenna structure as claimed in claim 12, wherein a length of the long portion of the slot is substantially equal to 0.25 wavelength of the first frequency band.

15. The antenna structure as claimed in claim 12, wherein a length of the short portion of the slot is substantially equal to 0.25 wavelength of the second frequency band.

16. The antenna structure as claimed in claim 12, wherein a length of the first radiation element is substantially equal to 0.5 wavelength of the second frequency band.

17. The antenna structure as claimed in claim 1, wherein a length of the second radiation element is from 3 mm to 7 mm.

18. The antenna structure as claimed in claim 6, further comprising:
a third radiation element, coupled to the narrow portion of the first radiation element, wherein the narrow portion of the first radiation element is disposed between the third radiation element and the second radiation element.

19. The antenna structure as claimed in claim 18, wherein a length of the third radiation element is from 2 mm to 6 mm.

20. The antenna structure as claimed in claim 6, further comprising:
a fourth radiation element, coupled to the wide portion of the first radiation element.
